(19) United States
(12) Patent Application Publication
(10) Pub. No.: US 2015/0164259 A1
(43) Pub. Date: Jun. 18, 2015

(54) MEMORY BUTTON MOUNT

(71) Applicant: Key Systems, Inc., Fishers, NY (US)

(72) Inventors: George H. Eckerdt, Victor, NY (US); George Mastrodonato, Rochester, NY (US)

(73) Assignee: Key Systems, Inc., Fishers, NY (US)

(21) Appl. No.: 14/568,304

(22) Filed: Dec. 12, 2014

Related U.S. Application Data
(60) Provisional application No. 61/916,121, filed on Dec. 13, 2013.

(51) Int. Cl. A47G 29/10; F16M 13/02

(52) U.S. Cl. CPC A47G 29/10; F16M 13/022

(57) ABSTRACT

A pocket mounted on a support structure can receive a tag carrying a memory button. The pocket is sized and configured to urge the tag toward the support structure and a contact surface of the memory button into electrical communication with a tag contact on the support structure. The pocket can include a slot into which a key flange of the tag can slide. The slot includes an end that acts as a stop for the key flange and ensures adequate alignment of the memory button and the tag contact.

### BACKGROUND

The present invention relates to memory button identification and mounting of keys and other security items.

Memory buttons or Dallas iButtons afford an inexpensive way to provide an ID associated with a security object. The security objects can be any object to which such memory buttons can be attached, and have been used with such objects as keys, cards, and other small and lightweight objects deserving security, such as small medicinal packages of liquids, pills, and capsules. The ID can be read electrically with a signal wire paired with a neutral wire for easy identification. However, packaging and mounting the objects to easily read a memory button associated with each object can pose challenges.

### SUMMARY

According to one embodiment of the present invention, a memory button mount can include a pocket having a main wall and two opposed sidewalls connected thereto, the opposed sidewalls each including at least one leg configured to extend into a support structure. The memory button mount can also include a tag configured to retain the memory button so that a contact surface of the memory button is substantially parallel to and spaced apart from a main body of the tag, the pocket being configured such that when mounted on a support structure, the pocket is configured to receive the tag with the main wall urging the tag and a contact surface of the memory button toward a support surface of the support structure.

Another embodiment of the invention disclosed herein can include a memory button mount having a tag bearing a memory button and a pocket connected to a support structure. The pocket can be configured to removably hold the tag and to urge the memory button toward a support surface of the support structure. A first contact on the support surface can be configured for electrical communication with a contact surface of the memory button when the tag is fully inserted into the pocket, and a second contact on the support surface can be configured for electrical communication with a contact surface of the memory button when the memory button is fully inserted into the pocket.

An additional embodiment of the invention disclosed herein can take the form of a memory button mount in which a tag can include a main body configured to retain a memory button with a contact surface of the memory button spaced apart from and substantially parallel to the main body and a contact surface of the memory button extending between the main body and the contact surface. In addition, the mount can include a pocket having at least three walls including a main wall and two opposed sidewalls extending substantially orthogonally from the main wall, each sidewall including a leg configured for insertion into a support structure, the sidewalls and main wall being sized and configured to receive the tag and the memory button. When the tag is inserted into the pocket, a first contact on the support surface is in electrical communication with the contact surface of the memory button.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic orthographic view of a memory mount according to embodiments of the invention disclosed herein.

FIG. 2 is a schematic orthographic view of a memory mount according to embodiments of the invention disclosed herein.

FIG. 3 is a schematic side view of a memory mount according to embodiments of the invention disclosed herein.

FIG. 4 is a schematic side view of a memory mount according to embodiments of the invention disclosed herein.

FIG. 5 is a schematic side view of a memory mount according to embodiments of the invention disclosed herein.

FIG. 6 is a schematic plan view of a sheet metal flat that can be used to form a tag of a memory mount according to embodiments of the invention disclosed herein.

FIG. 7 is a schematic orthographic view of a tag of a memory mount being formed from the sheet metal flat of FIG. 6 according to embodiments of the invention disclosed herein.

FIG. 8 is a schematic end view of the tag of a memory mount being formed of FIG. 7 according to embodiments of the invention disclosed herein.

FIG. 9 is a schematic orthographic back view of a tag of a memory mount without a memory button according to embodiments of the invention disclosed herein.

FIG. 10 is a schematic orthographic front view of a tag of a memory mount with a memory button according to embodiments of the invention disclosed herein.

FIG. 11 is a schematic side view of the tag of a memory mount of FIG. 10 according to embodiments of the invention disclosed herein.

FIG. 12 is a schematic end view of the tag of the memory mount of FIGS. 10 and 11 according to embodiments of the invention disclosed herein.

FIG. 13 is a schematic plan view of the tag of a memory mount of FIGS. 10-12 according to embodiments of the invention disclosed herein.

FIG. 14 is a schematic plan view of a sheet metal flat that can be used to form a pocket of a memory mount according to embodiments of the invention disclosed herein.

FIG. 15 is a schematic end view of a pocket of a memory mount formed from the flat of FIG. 14 according to embodiments of the invention disclosed herein.

FIG. 16 is a schematic plan view of a pocket of a memory mount formed from the flat of FIG. 14 according to embodiments of the invention disclosed herein.

FIG. 17 is a schematic side view of a pocket of a memory mount formed from the flat of FIG. 14 according to embodiments of the invention disclosed herein.

FIG. 18 is a schematic diagram of a security asset management system in which a memory mount according to embodiments of the invention disclosed herein can be used.

### DETAILED DESCRIPTION

Embodiments described in this application can provide a memory button mount that is simple, compact, durable, and effective in providing electrically readable IDs for security objects, such as keys. Memory buttons can be attached to tags connected to keys to give each key or group of keys an ID. The tags cooperate with respective pockets or cages attached to a support surface to mount the memory buttons to which they are connected. The pockets can bias the memory buttons toward the support surface to engage contacts so that each memory button can be read electrically. In addition, the pockets can facilitate removal and replacement of memory buttons, as well as keys connected thereto via the tags.

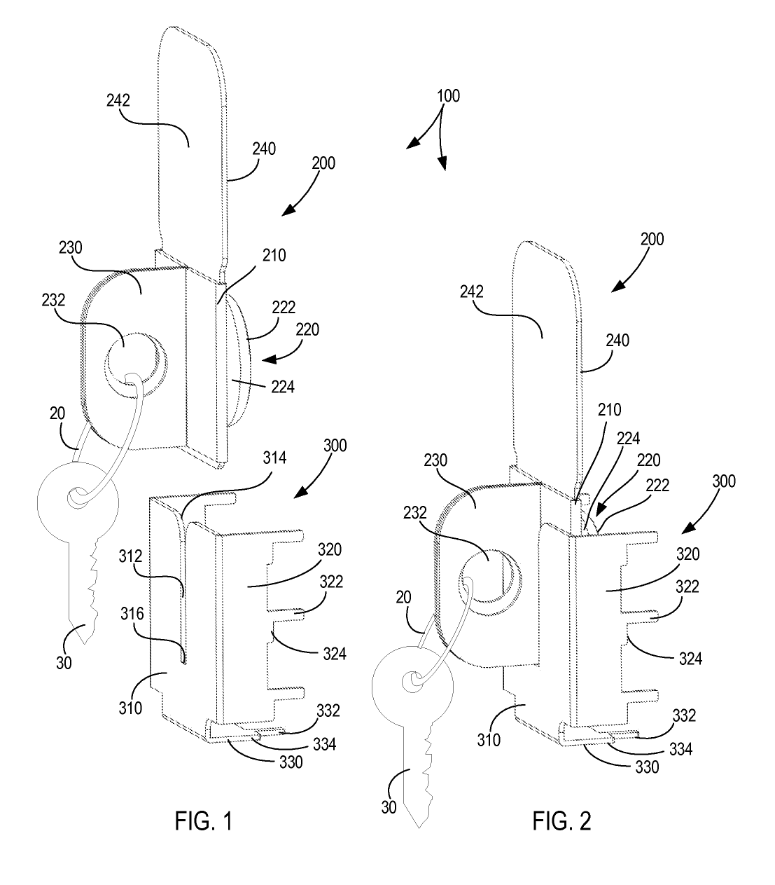

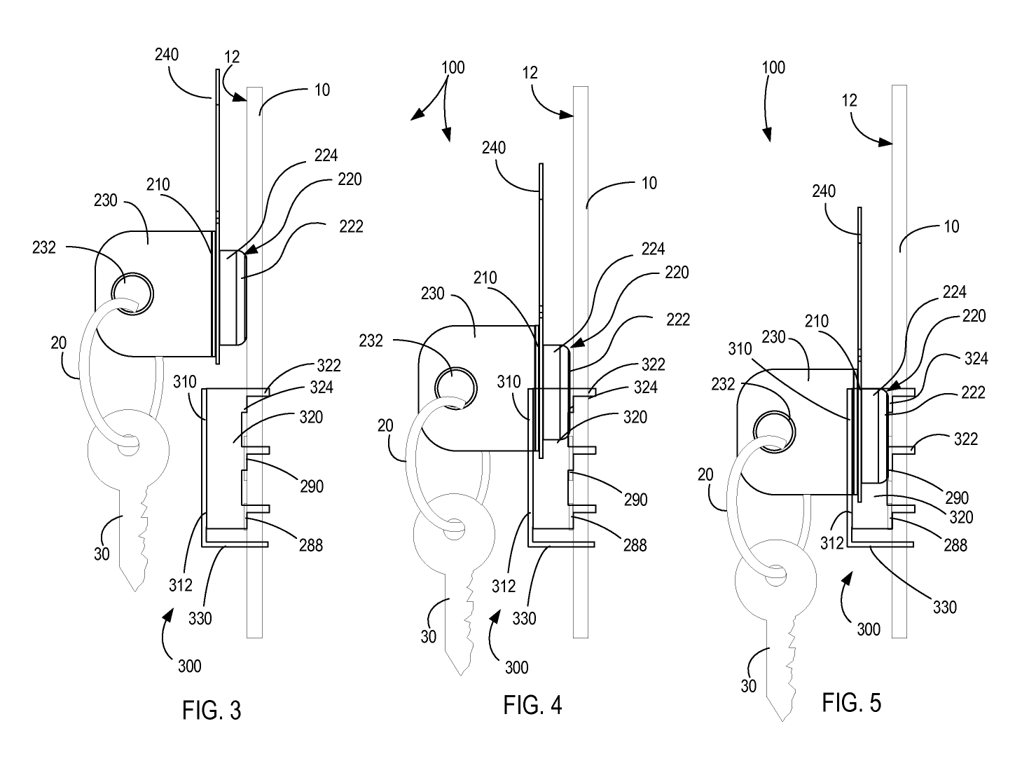

With reference to FIGS. 1-5, a mount 100 can include a tag 200 which can be inserted into a pocket or cage 300 attached to a support 10, which can include a support surface 12 (FIGS. 3-5). Tag 200 can include main body 210 that can hold a memory button 220. A key flange 230 can project from main body 210 and can include a ring passage 232 through which a key ring 20 or the like can pass to attach at least one key 30 to tag 200 or vice versa. A label flange 240 can also extend from main body 210 and can be used to bear indicia 242 or the like to identify tag 100 and/or associated keys attached thereto or vice versa.

As can be seen, tag 200 can be inserted into pocket or cage 300, with main body 210 sliding against an inner surface of a main wall 310 of pocket or cage 300 and key flange 230 sliding in a slot 312 of main wall 310 of pocket or cage 300. Slot 312 in embodiments can include rounded entry corners 314 to aid insertion of tag 200 into pocket or cage 300, and can include an end 316 that can stop key flange 230 at a desired point. Pocket or cage 300 can include opposed sidewalls 320 which can each bear at least one leg 322. Each leg 322 can include a knee 324 to hold sidewall 320 off of the support surface 12 (FIGS. 3-5). In embodiments, pocket or cage 300 can also include an end wall 330, which can also include at least one leg 332, which can each include a respective knee 334. Where end wall 330 is included, it can strengthen the connection between pocket or cage 300 and the support structure 10, though in embodiments the end wall 330 can be omitted.

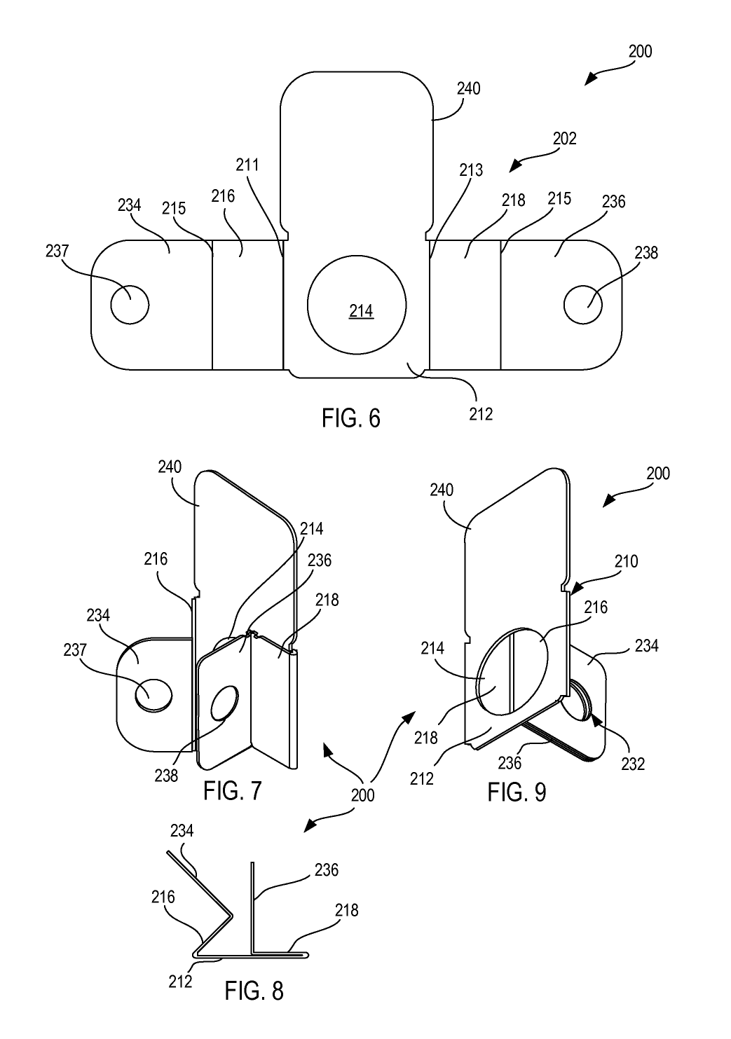

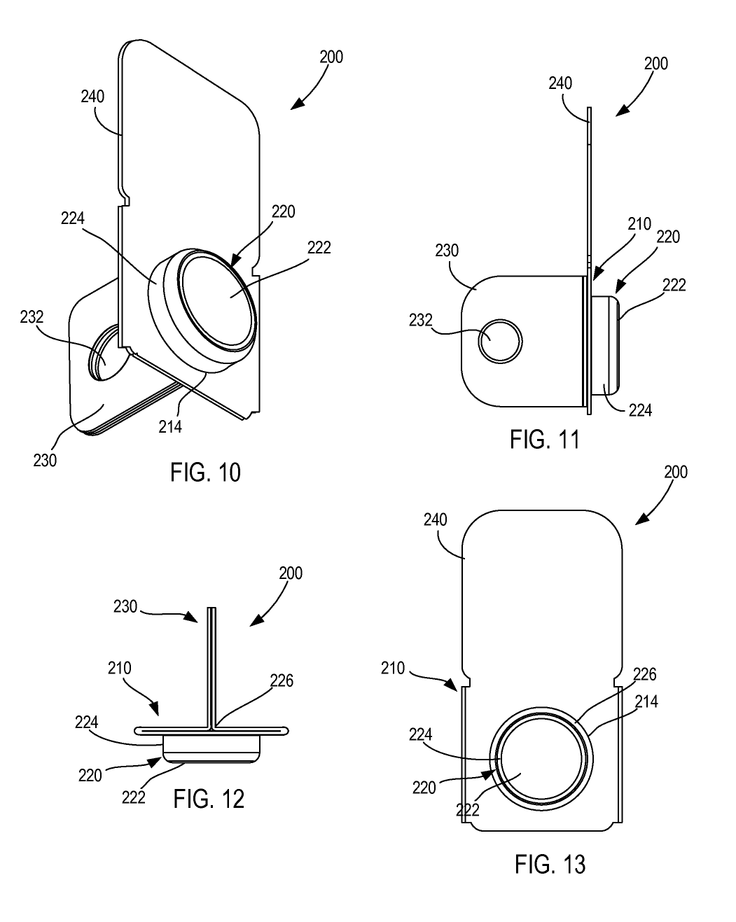

While tag 200 and pocket or cage 300 can be made from any suitable material and/or by any suitable method, embodiments include forming tag 200 and/or pocket or cage 300 from sheet metal. With reference to FIGS. 6-9, tag 200 can be formed from a flat 202, which can be formed from sheet metal or the like. Flat 202 can include a central main body portion 212 with a hole 214 therein through which memory button 220 can be inserted. Here button 220 is left out so that it does not obstruct the view of tag 200, but it should be understood that memory button 220 should be inserted through hole 214 before bending flat 202 to form tag 200. FIGS. 10-13 show tag 200 formed and with memory button 220 inserted therein. In particular, a rim 226 of memory button 226 can be engaged by portions of flat 202 and/or tag 200 to facilitate electrical communication with memory button 220.

As can particularly be seen in FIG. 6, flat 202 can include left and right main wall portions 216,218, as well as left and right key flange portions 234, 236. Each key flange portion 234, 236 can include a respective key passage hole 237, 238. Inner fold lines 211, 213 and outer fold lines 215, 217 are included in FIG. 6 for illustrative purposes, but it should be understood that these are not necessarily marked on flat 202. In embodiments, however, material along fold lines 211, 213, 215, 217 can be removed and/or thinned and/or perforated and/or otherwise weakened to reduce force required to bend the relevant portions of flat 202, as well as to reduce formation of sharp corners and/or edges during bending.

Referring again to FIGS. 6-9, left and right main wall portions 216, 218 can be folded in a first direction around inner fold lines 211, 213 toward central main body portion 212, with left and right key flange portions 234, 236 folded in a second, opposite direction around outer fold lines 215, 217 away from central main body portion 212. Left and right main wall portions 216, 218 can thereby press against memory button 220 (not shown in FIGS. 6-9) to retain it in hole 214. In addition, with left and right key flange portions 234, 236 aligned and/or in engagement, key passage holes 237, 238 can form key passage 232. Further, a grommet or the like can be inserted into key passage 232 to urge and retain key flange portions 234, 236 together, as well as to facilitate insertion of a key ring through key passage 232.

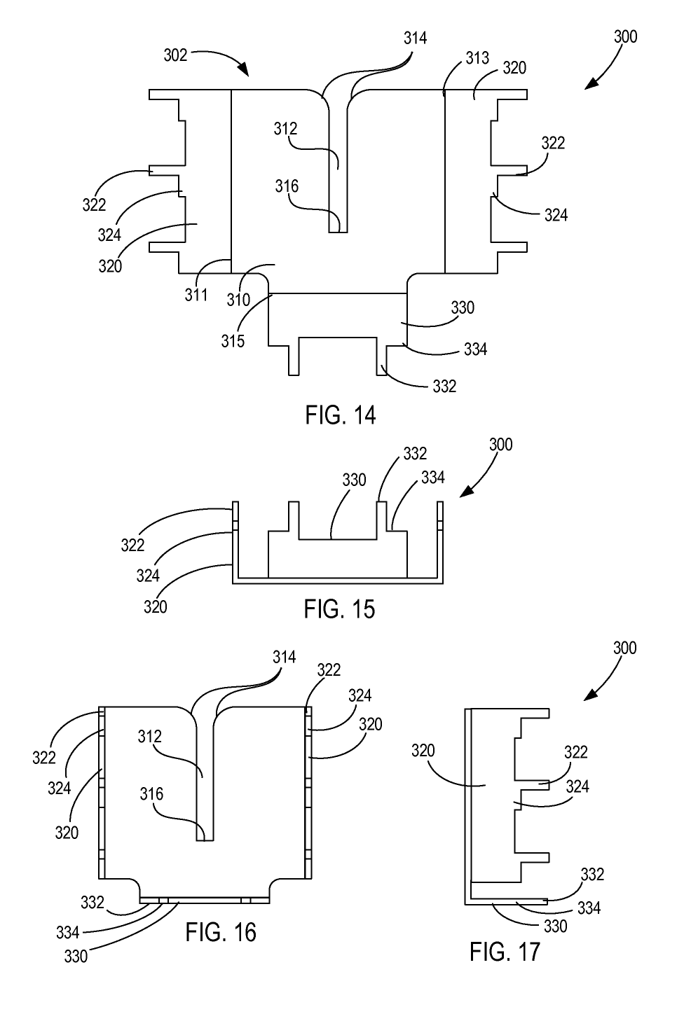

Like tag 200, pocket or cage 300 of embodiments can be formed from a flat 302, as seen in FIGS. 14-17. Flat 302 can include main wall 310 as a central portion thereof, with opposed sidewalls 320 included as left and right portions of flat 302. Where included, end wall 330 can be included as a bottom portion of flat 302. Flat 302 can include any or all features of pocket or cage 300, which can include slot 312, rounded entry corners 314, end 316 of slot 312, legs 322, 332, and/or knees 324, 334. Fold lines 311, 313, 315 are shown in FIG. 14, but are not necessarily marked on flat 302. In embodiments, as with tag 200, material along any or all of fold lines 311, 313, 315 can be removed and/or thinned and/or perforated and/or otherwise weakened to reduce bending force required and/or bulk of material in pocket or cage 300 when formed. Opposed sidewalls 320 can be folded in a first direction around fold lines 311, 313 until substantially perpendicular to main wall 310, and, where included, end wall 330 can be bent around fold line 315 until substantially perpendicular to main wall 310.

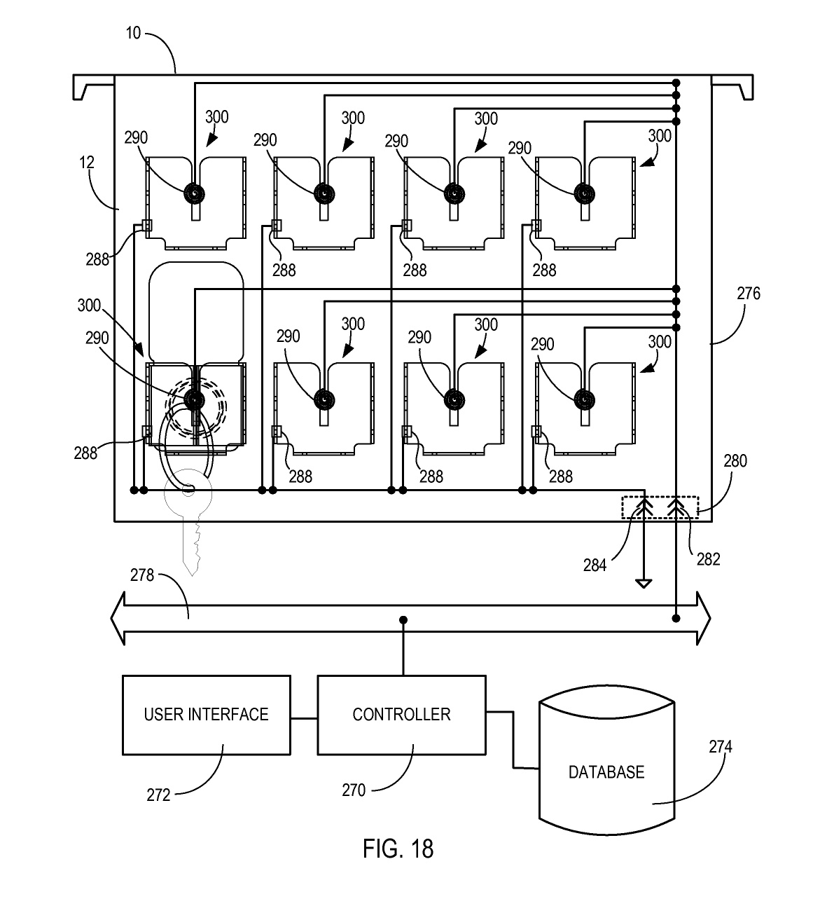

In embodiments, memory button mount 100 can be part of a security asset management system (SAM) in which support structure 10 can include a circuit board or the like. For example, as seen in FIG. 18, a SAM 40 can include a controller 270 coupled to a user interface 272 and a database 274 including user information and associated authentication information. Controller 270 can also be coupled to an asset panel 276 of support structure 10 via a 1-wire communication bus 278. The 1-wire communication bus refers to the fact that only one signal wire is needed (in addition to a ground connection) for communication. A suitable 1-wire communication bus may be implemented using the Dallas Semiconductor 1-wire protocol developed for their touch memory iButton devices and is familiar to those skilled in the art. Such touch memory iButton devices can be used as memory button 220 of embodiments of tag 200 and mount 100 described above.

A connector 280 can be provided on asset panel 276 to have a 1-wire signal connection 282 and a ground connection 284. A plurality of memory button mounts, here pockets or cages 300, can be present on asset panel 276, each pocket or cage 300 being mounted in electrical communication with a first electrical contact 288 on support surface 12 of panel 276 and over a second electrical contact 290 on support surface 12 of panel 276. Second electrical contacts 290 can be located so that, referring again to FIGS. 3-5 in conjunction with FIG. 18, when a tag 200 is inserted into a pocket or cage 300, a respective contact surface 222 of a respective memory button 220 can be in electrical communication with a respective second electrical contact 290. Second electrical contacts 290 can be coupled to 1-wire signal connection(s) 282 by circuit traces and/or other conductive paths, such as, but not limited to wires. Similarly, first electrical contacts 288 can all be coupled to ground connection 284 by circuit traces and/or other conductive paths, such as, but not limited to wires, and pockets or cages 300 can be in electrical communication therewith. For example, sidewalls 320 and/or legs 322 can be connected to first contacts 288, though other arrangements fall well within the scope of embodiments of the invention disclosed herein.

Using a 1-wire protocol, controller 270 can query the asset panel 276 coupled to 1-wire bus 278 to see what, if any, memory button identification tags 200 are plugged into pockets or cages 300. If a memory button 220 is present, it will respond to a query from controller 270, letting the controller know the memory button (and therefore the asset associated with the memory button) is present. Depending on the embodiment, a greater or fewer number of pockets or cages 300 can be present on a given asset panel 276, and more than one asset panel 276 could be coupled to 1-wire communication bus 278 at the same time.

In embodiments, pocket or cage 300 and tag 200 can be sized so that insertion of tag 200 into pocket or cage 300 results in a snug fit or even a slight interference fit to ensure that contact surface 222 of memory button 220 has sufficient electrical contact with contact 290. In addition, main wall 310 of pocket or cage 300 can be bent in such a way as to exert a spring force on tag 200 when tag 200 is inserted, urging substantially planar contact surface 222 against support surface 12 and/or contact 290.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A memory button mount comprising:
a pocket having a main wall and two opposed sidewalls connected thereto, the opposed sidewalls each including at least one leg configured to extend into a support structure; and
a tag configured to retain the memory button so that a contact surface of the memory button is substantially parallel to and spaced apart from a main body of the tag;
the pocket being configured such that when mounted on a support structure, the pocket is configured to receive the tag with the main wall urging the tag and a contact surface of the memory button toward a support surface of the support structure.

2. The memory button mount of claim 1 wherein the tag places a contact surface of the memory button in electrical communication with a first contact on the support surface.

3. The memory button mount of claim 2, wherein the main body portion of the tag includes an electrically conductive material that engages the contact surface of the memory button and that engages the pocket.

4. The memory button mount of claim 3, wherein the pocket main wall and at least one opposed sidewall include an electrically conductive material configured to provide electrical communication between the tag and the first contact.

5. The memory button mount of claim 1, wherein the pocket is configured to retain the tag such that the contact surface of the memory button is in electrical contact with a contact on the support surface

6. The memory button mount of claim 5, wherein the main body of the tag includes a key flange extending therefrom and the pocket main wall includes a slot sized to receive the key flange, the slot extending substantially parallel to the opposed sidewalls and including an end located such that, when the key flange engages the end, the memory button contact surface engages the contact on the support surface.

7. The memory button mount of claim 6, wherein the slot includes rounded entry corners.

8. The memory button mount of claim 6, wherein the key flange includes a key ring passage configured to receive a key ring therethrough.

9. A memory button mount comprising:
a tag bearing a memory button;
a pocket connected to a support structure and configured to removably hold the tag and to urge the memory button toward a support surface of the support structure;
a first contact on the support surface configured for electrical communication with a contact surface of the memory button when the tag is fully inserted into the pocket; and
a second contact on the support surface configured for electrical communication with a contact surface of the memory button when the memory button is fully inserted into the pocket.

10. The memory button mount of claim 9, wherein the pocket includes an electrically conductive material extending from the first contact to a contact surface of the pocket.

11. The memory button mount of claim 10, wherein the pocket includes a main wall and two opposed sidewalls, each sidewall including at least one leg configured to extend into the support structure, and the first contact is in electrical communication with at least a leg of the at least one leg.

12. The memory button mount of claim 11, wherein the main wall includes an inner surface facing the support structure, the tag includes a main body configured to hold the memory button, and the main wall inner surface engages the main body when the tag is inserted into the pocket.

13. The memory button mount of claim 12, wherein the tag main body includes an electrically conductive material engaging the contact surface of the memory button and the inner surface of the pocket main wall.

14. The memory button mount of claim 13, wherein the tag and the pocket are made from a metal.

15. The memory button mount of claim 13, wherein the tag and the pocket are made from stamped sheet metal flats bent to form the tag and the pocket.

16. A memory button mount comprising:
a tag including a main body configured to retain a memory button with a contact surface of the memory button spaced apart from and substantially parallel to the main body and a contact surface of the memory button extending between the main body and the contact surface;
a pocket having at least three walls including a main wall and two opposed sidewalls extending substantially orthogonally from the main wall, each sidewall including a leg configured for insertion into a support structure, the sidewalls and main wall being sized and configured to receive the tag and the memory button;
whereby when the tag is inserted into the pocket, a first contact on the support surface is in electrical communication with the contact surface of the memory button.

17. The memory button mount of claim 16, wherein the tag main body and at least a sidewall of the pocket include a metal, and the electrical connection includes the metal of the tag main body and the at least a sidewall.

18. The memory button mount of claim 17, wherein the tag main body and the pocket are formed from a metal.

19. The memory button mount of claim 18, wherein the tag main body is formed from stamped sheet metal, a flat of the tag main body including left and right main body portions and a central main body portion, the central main body portion including a hole configured to receive the memory button, and the left and right main body portions being folded over the central main body portion to retain the memory button therein.

20. The memory button mount of claim 19, wherein the tag further comprises a key flange formed from the left and right main body portions.
